(19) United States
(12) Patent Application Publication
(10) Pub. No.: US 2006/0076441 A1
(43) Pub. Date: Apr. 13, 2006

(54) Grinder assembly

(76) Inventor: Chung-Jen Pai, Taipei Hsien (TW)

Correspondence Address: Dougherty & Troxell;ONE SKYLINE PLACE, SUITE 1404, 5205 LEESBURG PIKE, FALLS CHURCH, VA, 22041, US

(21) Appl. No.: 11/000,052

(22) Filed: Dec. 1, 2004

(30) Foreign Application Priority Data
Oct. 13, 2004 (TW) 093216267

(51) Int. Cl. A47J 43/00

(52) U.S. Cl. 241/169

(57) ABSTRACT

A rod head, a main body, a tail portion, a spring, and a grinding rod; by screws said grinding rod with rod head and screws said tail portion with bottom section of main body, the movement of grinding rod reciprocally with tube thread to grind the material to be grinded.

### BACKGROUND OF THE INVENTION

1. Field of the Invention

The present invention is relating to a grinder, especially to a hand-operated grinder and further provides a feeding bottle to feed the raw material, such as pepper beans in avoiding the material drop down outside the grinder.

2. Description of the Prior Art

The use of grinder, especially the use of hand-operated grinder lasts a very long period. For example, the use of pepper miller has a longer history. Relating prior arts such as U.S. Pat. No. 2,679,360 in 1954, U.S. Pat. No. 2,698,719, recent U.S. Pat. No. 6,595,447 as well as German utility model DE 20,203,057. All of these prior arts disclose the workable pepper miller.

In fact, from the viewpoint of research and development, even the old or traditional product, if can be provided by new structure or function, the new value thereby created. For example, as to the conventional grinder, except the structure can be improved, actually, the most significant drawback is sanitary problem. That means the object to be grinded, such as but not limited to pepper berry, must be fed into the grinder for grinding. Due to the end portion of grinding rod is always exposed outside the bottom of main body of grinder, therefore, feeding the pepper beans through a ring-shaped passage is something difficult by free hand feeding. Unavoidable, the pepper beans always drop outside the grinder. Furthermore, the upper portion of grinder rod as well as spring is always exposed outside the main body, which may cause the pollution.

### SUMMARY OF THE INVENTION

The primary object of the present invention is to provide a grinder with shielded grinding rod and spring. Furthermore, the present invention also provides a feeding bottle to solve the feeding problem and make the feeding more convenience.

### BRIEF DESCRIPTION OF DRAWINGS

FIG. 1 is the sectional view of the grinder of the present invention.

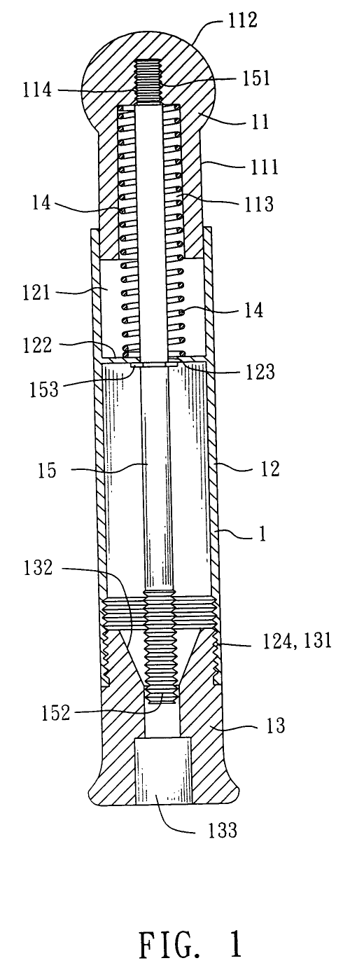

FIG. 2 is the perspective view of the grinder assembly of the present invention.

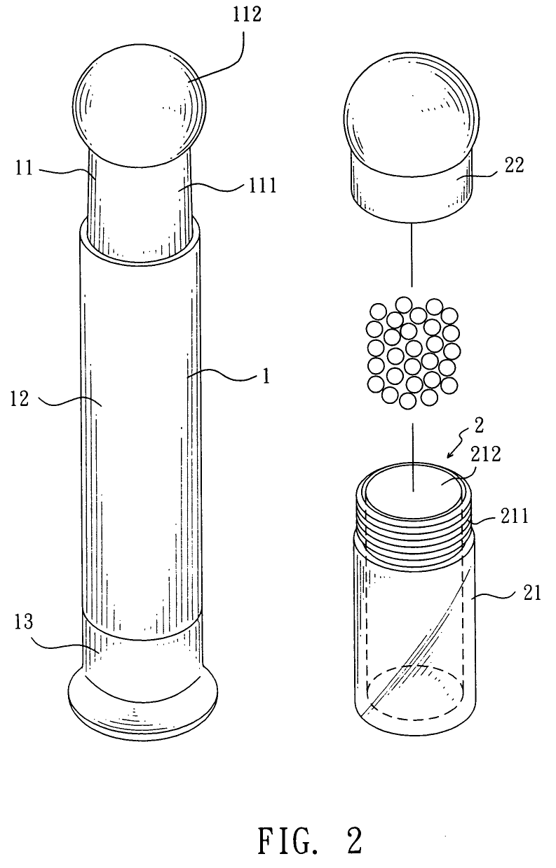

FIG. 3 is the perspective view of the present invention in feeding situation.

### DETAILED DESCRIPTION OF THE PREFERRED EMBODIMENT

As shown in the drawings, the present invention including a grinder 1 and a feeding bottle 2 as well as their assembly.

The grinder 1 further comprises a rod head 11, a main body 12, a tail portion 13, a spring 14 and a grinding rod 15.

Rod head 11 is a housing with a shell section 111 and a press portion 112. The bottom of said shell section 111 is an opening and extending upwardly a shell hole 113 to receive said spring 14 and grinding rod 15. Inside the press portion 112, there is a screw hole 114 which connecting to said shell hole 113 for screwing said grinding rod 15.

Main body 12 is a hollow tube with a tube hole 121 which has the larger inner diameter than the outer diameter of said shell section 111. In order to separate the press section and receiving section of pepper berry, there is a separating piece 122 provided inside said main body 12. Said separating piece 122 further provides a separating hole 123 which enable said grinding rod 15 to pass through. Meanwhile, in order to screw said tail portion 13, therefore, on the bottom of inner wall provides a section of tube thread 124.

The outer wall of tail portion 13 provides a section of tail thread 131 which can be screwed with said tube thread 124 respectively. Inside the top portion of said tail portion 13 provides a cone-shaped reservoir 132 and further connecting an output hole 133. Therefore, in operation, the reservoir 132 receives the pepper beans to be grinded and the grinded powder or particles can fall down through said output hole 133.

The outer diameter of spring 14 is corresponding to the diameter of said tube hole 121. Therefore, when assembly, one end of said spring 14 is received by said shell hole 113 and the other end of said spring 14 is positioned on said separating piece 122.

Grinding rod 15 is a rod and one end provides the grinding thread 151 which can be screwed with said screw hole 114 while the other end provides a section of grinding teeth 152. On the middle portion, further provides a baffle piece 153 to prevent said grinding rod 15 moving upwardly.

Refer to the drawings, when assembly, the grinding thread 151 section of grinding rod 15 pass through separating hole 123 and spring 14 then screws with screw hole 114. The material to be grinded can be fed into the main body 12 and screws with tail portion 13. When press the rod head 11, the material received in reservoir 132 will be grinded by tube thread 124 and grinding teeth 152 respectively and the grinded powder or particle will fall down through output hole 133.

As shown in drawings, when feeding material to be grinded, the tail portion 13 can be disassembled from main body 12, then, the main body 12 can be up side down for feeding putting material. Due to the grinding rod 15 is exceeding or very close the bottom of main body 12, therefore, it is something inconvenience and the material may drop outside the main body 12.

For better feeding, the present invention further provides a feeding bottle 2. Refer to the drawings, the feeding bottle 2 is a container at least has a bottle body 21 for receiving the material to be grinded and may further provides a closing device 22. In the outer wall of bottleneck of said bottle body 21, further provides a section of bottle thread 211 which corresponding to said tube thread 124 and enable to screw each other respectively. The volume of inner space 212 of feeding bottle 2 preferably corresponds to the space of lower section under said separating piece 122 of said main body 12.

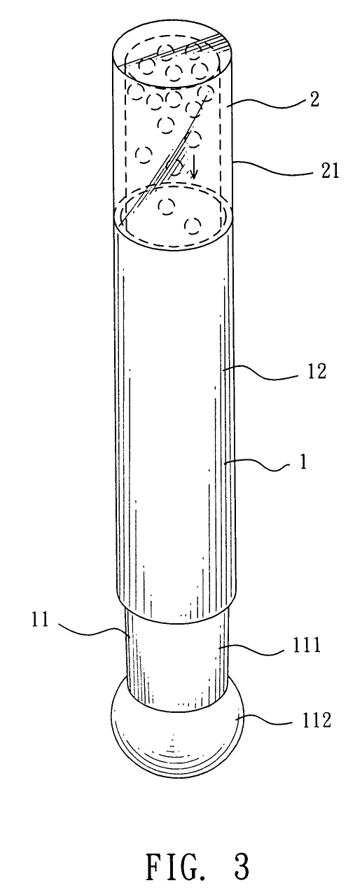

Therefore, as shown in FIG. 3, when the material to be grinded, such as but not limited to pepper berry put into said inner space 212 of said feeding bottle 2, then, by screwing the bottle thread 211 to said tube thread 124 and turning the direction of up side down, the grinding material can be fully fed into the lower portion of main body 12. By the way, the drawback of material falling outside the main body can be avoided.

In conclusion, excepting feeding the material easier and convenience, through the practice of the present invention, the spring will not be exposed and the sanitary problem can be solved.

Although the present invention has been illustrated and described with reference to the preferred embodiments thereof, it should be understood that it is in no way limited to the details of such embodiment but is capable to numerous modifications within the scope of the appended claims.

What is claimed is:

1. A grinder, comprising:
a rod head having a section of shell section and the press portion, said shell portion having a opening and a shell hole which extending to a screw hole provided inside the press portion;
a main body having a tube hole with the diameter larger than the outer diameter of said shell section, inside the tube hole providing a separating piece which having a separating hole, the inner wall of bottom section further providing tube thread;
a tail portion having the tail thread on the outer wall of bottom section which corresponding to said tube thread, upper portion inside having a reservoir and extending to a output hole;
a spring having the outer diameter smaller than tube hole;
a grinding rod having a grinding thread which corresponding to said screw hole provided on the top section, bottom section having grinding teeth and middle portion providing a baffle piece which having larger outer diameter than separating hole;
by screws said grinding rod with rod head and screws said tail portion with bottom section of main body, the movement of grinding rod reciprocally with tube thread to grind the material to be grinded.

2. The grinder as claimed in claim 1, wherein said reservoir is conic shape.

3. The grinder as claimed in claim 1, wherein said grinder is made by metal.

4. A feeding bottle for grinder, which having a section of bottle thread on the outer wall of bottleneck, said bottle thread is corresponding to the thread of bottom section of main body of said grinder and which enable for feeding after screw each other.

5. The feeding bottle for grinder as claimed in claim 4, wherein the volume of inner space of said bottle is corresponding to the space of lower inner space of lower portion of main body of said grinder.

6. The feeding bottle for grinder as claimed in claim 4, wherein said feeding bottle further comprises a closing device.

7. An grinder assembly, comprising:
a grinder,
a feeding bottle having the size of opening corresponding to the input opening of said grinder, whereby the material to be grinded can be fed after connecting each other.

8. The grinder assembly as claimed in claim 7, wherein the volume of inner space of said bottle is corresponding to the space of reservoir of said grinder.

9. The grinder assembly as claimed in claim 7, wherein the connection between feeding bottle and main body of said grinder is by screw thread.

10. The grinder assembly as claimed in claim 7, wherein said feeding bottle further provides a closing device.
